(19) United States
(12) Patent Application Publication
(10) Pub. No.: US 2011/0041372 A1
(43) Pub. Date: Feb. 24, 2011

(54) Non-Adhesive Acrylic Photo Album Or Folio Holder

(76) Inventor: Michael Jon Daniel, St. Louis, MO (US)

Correspondence Address: Eli Weiss, Esq.;Oakwood Law Group, LLP, 14 Bond Street -- SUITE 386, Great Neck, NY, 11021, US

(21) Appl. No.: 12/862,734

(22) Filed: Aug. 24, 2010

Related U.S. Application Data
(60) Provisional application No. 61/236,239, filed on Aug. 24, 2009.

(51) Int. Cl. B42D 3/12

(52) U.S. Cl. 40/726

(57) ABSTRACT

An album having a front cover or a picture frame for displaying at least one photograph comprises a back portion having at least four side edges where two of the side edges are a top edge and a bottom edge and two of the side edges are a left edge and a right edge and a frame having a straight edge on each of the four inside edges located on top of the back portion. A transparent sheet adapted to be located within the frame having dimensions which are equal to the inside dimensions of the frame and at least one edge which is half round with a radius of one half the thickness of the transparent sheet.

### REFERENCE TO RELATED APPLICATIONS

This patent application claims the benefit of U.S. Provisional Application No. 61/236,239 filed on Aug. 24, 2009, the disclosure of which is incorporated herein by reference in its entirety.

### BACKGROUND OF THE INVENTION

1. Field of the Invention

The present invention relates to an apparatus and method for providing a front cover to a picture album or a picture frame by attaching a sheet of transparent acrylic or a substrate to the inside perimeter of a flexible trapezoid shape frame where two of the four sides such as the top and bottom sides are parallel to each other and at least the left or right side converges toward the opposite side at an angle of between fifteen degrees and eighty degrees where the sheet of acrylic or substrate is attached to the frame by simply pressing down on the sheet of acrylic until it snaps into place. The invention allows a user to add and or remove photographs of images under the acrylic or substrate without using an adhesive and within seconds without damaging the original image.

2. Description of Related Art

The use of photo albums for the purpose of displaying photographs is known in the prior art. More specifically, by way of example, U.S. Pat. No. 7,278,232 to Kleissler discloses a base layer, an anchoring layer, and a protective layer. The anchoring layer is attached to the base layer and includes a plurality of mounting apertures for attaching a flat article to the page. The protective layer covers the article.

U.S. Pat. No. 6,926,307 to Mathews-Lingen discloses a photo journal scrapbook which includes pocket pages for large items, and each page has two different sides so that when the photo journal scrapbook is opened, frames for displaying photographs are present on one page, while lines with text prompts are present on the other page.

U.S. Pat. No. 6,799,391 to Bergholtz discloses corner mounts for photographs where each corner mount includes a paper base sheet and a cap adhesively attached to each other to define a pocket for a corner of the article to be mounted. The underside of the base sheet has a pressure-sensitive adhesive that is covered by an easily separated liner.

U.S. Pat. No. 6,511,245 to Tan discloses a photograph album having a rectangular backing sheet with an upper and a lower edge and an interior edge and an exterior edge with an upper and a lower surface. A plurality of holes are formed through the sheet for receiving a photograph. A rectangular transparent bag is provided for receiving photographs.

U.S. Pat. No. 6,401,376 to Cumberland discloses a backing substrate which has an adhesive layer on one side and retaining pockets on a second side. The retaining pockets form a frame along two, three or all four sides of a photograph and engages the photograph along at least three sides.

U.S. Pat. No. 6,322,272 to Solis discloses a photograph album having an outer cover and a plurality of pages. Each of the pages includes a rigid back portion and a transparent front portion where the back portion receives photographs and meltable segments are located on the periphery of the photographs and on the back portion.

U.S. Pat. No. 6,266,907 to Matteau discloses an album page for displaying photographs having an intermediate, opaque sheet and a pair of transparent outer sheets. Die cuts are provided in the immediate sheet to permit display of rectangular objects in either horizontal or vertical positions.

U.S. Pat. No. 5,040,216 to Policht discloses a photo album which has a cover formed of two sheets of plastic hinged to a spine panel where each cover includes a pocket that receives a paperboard stiffener. A flexible hinge tape, having two adhesive-coated strips separated by a non-adhesive hinge strip is used to mount the hinge tape along the edge of a binder member, and the other adhesive strip mounts a photo on the binder member.

### SUMMARY OF THE INVENTION

In an exemplary embodiment of the present invention, there is disclosed an album having a front cover or a picture frame for displaying at least one photograph comprises a back portion having at least four side edges where two of the side edges are a top edge and a bottom edge and two of the side edges are a left edge and a right edge and a frame having a straight edge on each of the four inside edges is located on top of the back portion. In another embodiment the inside edges of the left and right sides of the frame are beveled or slope at an angle of between thirty degrees and sixty degrees where a bevel or slope of forty five degrees is preferred. Thus, in this embodiment the width of the top surface of the left and right sides of the frame is wider than the width of the bottom surface of the left and right sides of the frame. A transparent sheet is adapted to be located within the frame which has a vertical dimension that is equal to the inside vertical dimension of the frame and a horizontal dimension which is greater than the inside horizontal dimension of the top surface of the frame but less than the inside horizontal dimension of the bottom surface of the frame. At least one side edge and preferably each of the side edges of the transparent sheet is half round with a radius of one half the thickness of the transparent sheet.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a top perspective view of a cover of a photo album having a trapezoid shaped flexible frame with at least one side that is cut at an angle and which is located on a back portion where a sheet of transparent plastic can be snapped into the frame for displaying a photo located under the transparent plastic in accordance with the principles of the invention;

FIG. 2 is a view along the line 2-2 of FIG. 1 showing the straight inside edge of the frame and the back portion in accordance with the principles of the invention. In another embodiment the inside edges of the left and right sides of the frame are beveled or slope at an angle of between thirty degrees and sixty degrees where a bevel or slope of forty five degrees is preferred. In this embodiment the top surface of each of the side members of the frame is wider than the width of the bottom surface of each of the side members of the frame.

FIG. 3 is a top view of a sheet of transparent plastic having top and bottom sides which are parallel to each other and left and right sides which converge toward each other; and

FIG. 4 is a top perspective view of the cover of an album with a sheet of transparent plastic placed over photographs and snapped into grooves in the frame.

### DESCRIPTION OF THE PREFERRED EMBODIMENT

The present invention relates to an apparatus and method of attaching a piece of clear transparent plastic such as a sheet of acrylic or substrate of, for example, a sheet of Plexiglas to a photo album or folio using no adhesive. The invention allows a user to change images under the acrylic or substrate within seconds without damaging the original image by snapping the transparent plastic into a frame. No adhesive is needed to hold a photograph or artwork firmly in place. The photograph under the acrylic or substrate can be easily changed at any time without damaging or altering the photograph or artwork.

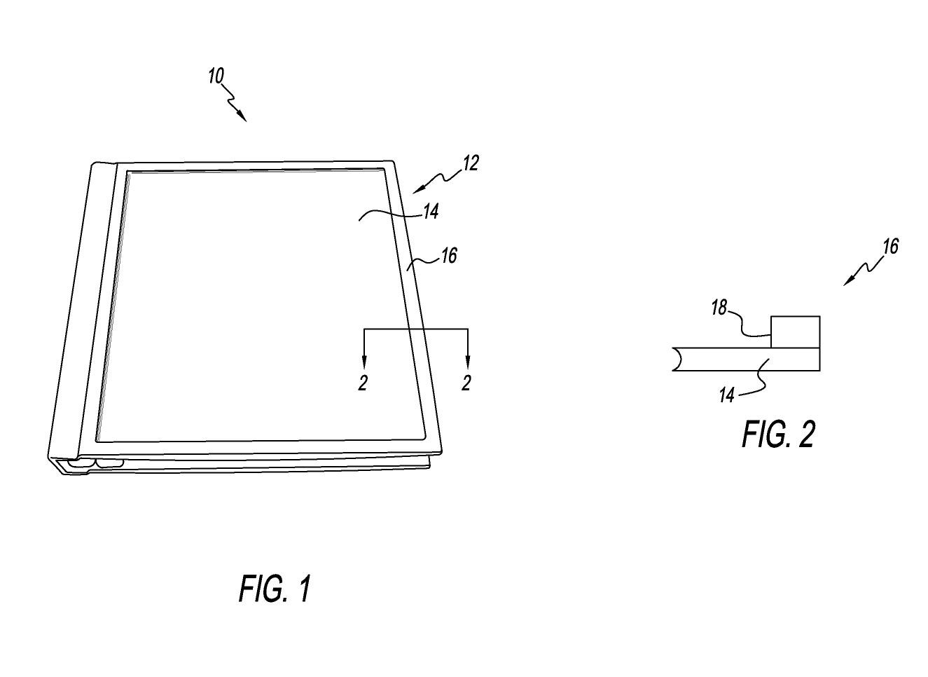

Referring to FIG. 1 there is shown a top perspective view of the cover of a photo album generally designated by reference numeral 10 having a frame located on a back sheet where the frame has at least one side that converges toward the opposites side and where a sheet of transparent plastic can be locked to the inside edges of the frame for displaying a photograph located under the transparent plastic.

Specifically, it will be noted that the various FIGS. relate to a picture frame or the cover of a photograph album which has holding means for keeping photographs in place within the frame. In its broadest context, the device consists of a free standing frame or a frame on an album where a clear sheet of plastic is simply pressed down until it snaps into the frame to lock the sheet of plastic to the frame.

The album 10 can have front and back outer covers with a plurality of pages 12 there between. The cover of the album includes a flexible back portion 14, a frame 16 where the inside perimeter has substantially square edges 18, and a transparent front portion such as a sheet of Plexiglas or any clear plastic which is removably attached to the frame by being snapped into the frame 16. The space between the back portion 14 and the transparent front portion is adapted to receive photographs or folio.

The flexible or semi-flexible frame 16 has a trapezoidal shape where the top and bottom sides are parallel to each other and the left and right sides converge toward each other to provide a frame that is wider at the bottom than at the top. Each side can have a slope of between fifteen degrees and eighty degrees where a preferred slope angle is forty five degrees. The frame can have various dimensions of, for example, five inches by five inches, eight inches by ten inches, twelve inches by eighteen inches, ten by twenty inches, etc. The thickness of the frame is at least equal to the thickness of the sheet of clear plastic, and preferably the frame should have a thickness of one sixteenth of an inch greater than the thickness of the sheet of clear plastic.

In another embodiment the left and right sides of the trapezoid shaped frame can be parallel to each other and one or both of the top and bottom sides can converge toward the other. When the frame is the top cover of an album or on the top cover of an album, it is preferred that the long dimension of the frame, for example the left side of the frame, be near the hinge of the album and that either the left or right, or both the left and right sides of the frame converge toward each other. In addition, it is preferable that the frame is wider at the bottom than at the top.

Referring to FIG. 2, there is a view along the line 2-2 of FIG. 1 showing a sectional view of the flexible or semi-flexible frame 16 on the back portion 14. The inside edge 18 of the frame 16 is a straight edge which forms a substantially right angle with the top and bottom surfaces of the frame.

In another embodiment the inside edges of the left and right sides of the frame are not straight edges but are beveled or slope at an angle of between thirty degrees and sixty degrees where a bevel or slope of forty five degrees is preferred. In this embodiment the width of the top surface of the left and right side members of the frame is wider than the width of the bottom surface of the left and right side members of the frame. In this embodiment a transparent sheet is adapted to be located within the frame which has a vertical dimension that is equal to the inside vertical dimension of the frame and a horizontal dimension which is greater than the inside horizontal dimension of the top surface of the frame but less than the inside horizontal dimension of the bottom surface of the frame. At least one side edge and preferably each of the side edges of the transparent sheet is half round with a radius of one half the thickness of the transparent sheet.

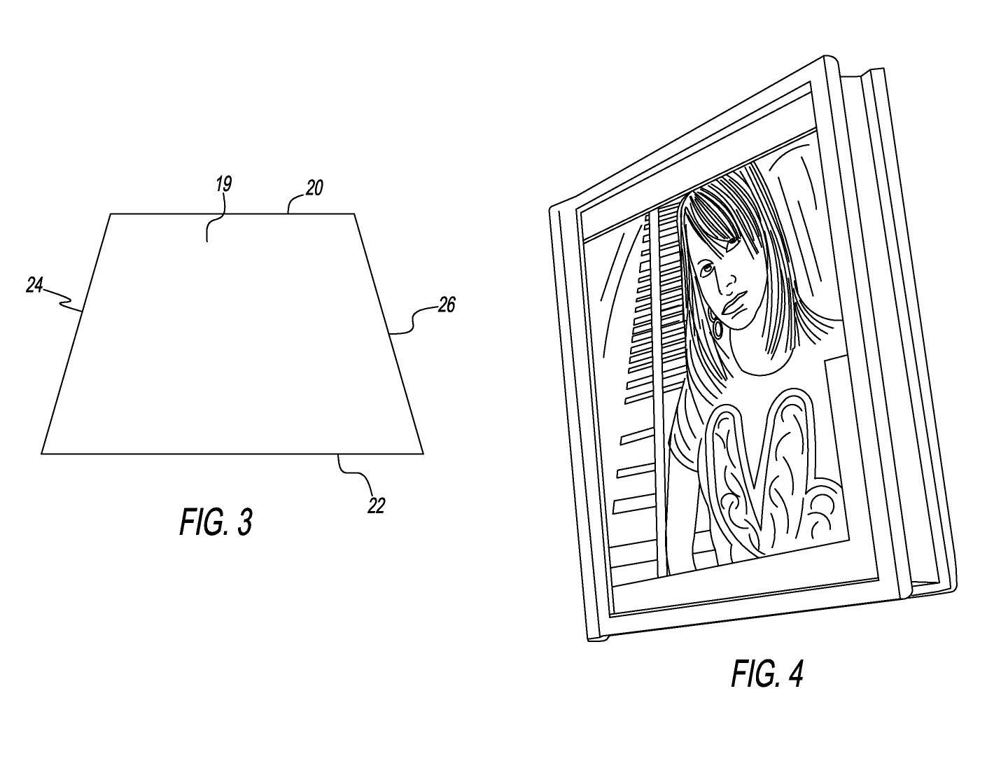

Referring to FIG. 3, there is shown a top view of a sheet of clear plastic 19 which is configured to be placed in a flexible of semi-flexible frame where the top 20 and bottom 22 sides are parallel to each other and the left 24 and right 26 sides each converge toward each other. The sheet of clear plastic 19 can be a sheet of, for example, Plexiglas with a thickness of about one quarter of an inch. The dimensions of the sheet of clear plastic are equal to the inside dimensions of the flexible or semi-flexible frame into which it is to be placed. No clearance is provided. The top and bottom inside edges of the clear plastic are straight and form right angles with the front and back sides of the clear plastic. The left and/or right inside edges of the clear plastic are half round circles having a radius of one half the thickness of the sheet of clear plastic. Thus, where the clear plastic has a thickness of one quarter of an inch, the side edges of the clear plastic will have a radius of one eighth of an inch.

In use, one of more photographs or artwork is placed on the flexible back portion within the flexible or semi flexible frame and, with the sheet of clear acrylic plastic tilted at a forty degree angle, a round edge of the sheet of clear acrylic plastic is placed against the straight inside edge of the left side of the frame. The opposite or right half round edge on the sheet of clear acrylic is now moved down until it touches the right side of the frame at which time pressure is applied to the right side edge of the sheet of acrylic plastic until it snaps into the frame. The straight edges of the sheet of clear acrylic or substrate slide into position next to the top and bottom inside edges of the frame and the sheet of clear acrylic or substrate is locked to the frame.

To remove the sheet of clear acrylic from the frame, a person simply bends a corner of the frame down until the corner of the sheet of acrylic pops up out of the frame and the corner of the sheet of acrylic is then lifted up and out of the frame.

Referring to FIG. 4, there is shown a top perspective view of an album cover with a sheet of clear plastic placed over photographs and snapped into the frame.

When a photograph is located between the flexible back portion and the sheet of clear acrylic plastic or substrate, the photograph or artwork is both protected from harm and is visible through the acrylic sheet. The sheet of clear acrylic is held firmly in place without any adhesive.

The invention disclosed can be used to display a photograph or artwork on an album or folio and the displayed item can be changed at any time without damaging the photo or artwork. To remove the clear acrylic sheet, a corner of the frame is bent away from the clear acrylic sheet or substrate until the edge of the acrylic or substrate pops above the frame, at which time the acrylic sheet can be removed from the frame.

In one application, this invention can be used in the awards industry to allow employee of the month photo to be easily changed.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An album having a front cover or a picture frame for displaying at least one photograph comprising
a back portion having at least four side edges where two of the side edges are a top edge and a bottom edge and two of the side edges are a left edge and a right edge;
a frame having a straight edge on each of the four inside edges located on top of the back portion; and
a transparent sheet sized to fit within the frame;
wherein at least one edge of the transparent sheet is half round with a radius of one half the thickness of the transparent sheet.

2. The album or frame of claim 1 wherein the frame is flexible.

3. The album or frame of claim 2 wherein at least one side edge of the frame converges toward an opposite side.

4. The album or frame of claim 3 wherein the dimensions of the transparent sheet are equal to the inside dimensions of the frame.

5. The album or frame of claim 4 wherein the thickness of the frame is at least equal to the thickness of the transparent sheet.

6. The album or frame of claim 5 wherein the transparent sheet is a sheet of clear acrylic.

7. The album or frame of claim 6 wherein the sheet of clear acrylic is Plexiglas.

8. The album or frame of claim 6 wherein the sheet of clear acrylic has a thickness of about one quarter of an inch.

9. The album or frame of claim 3 wherein two opposing side edges of the frame converge toward each other.

10. The album or frame of claim 9 wherein left and right side edges of the frame converge toward each other and the top and bottom side edges are parallel to each other.

11. The album or frame of claim 10 wherein the left and right edges of the frame converge at an angle of between fifteen degrees and eighty degrees.

12. The album or frame of claim 11 wherein the left and right edges of the frame converge at an angle of between thirty degrees and sixty degrees.

13. The album or frame of claim 12 wherein the left and right edges of the frame converge at an angle of forty five degrees.

14. A method for providing an album having a front cover or a picture frame for displaying at least one photograph comprises
providing a back portion having at least four side edges where two of the side edges are a top edge and a bottom edge and two of the side edges are a left edge and a right edge;
locating a frame having a straight edge on each of the four inside edges on top of the back portion; and
providing a transparent sheet sized to fit within the frame;
wherein at least one edge of the transparent sheet is half round with a radius of one half the thickness of the transparent sheet.

15. The method of claim 14 wherein the frame is flexible.

16. The method of claim 15 wherein at least one side edge of the frame converges toward an opposite side.

17. The method of claim 16 wherein the dimensions of the transparent sheet are equal to the inside dimensions of the frame.

18. The method of claim 17 wherein the thickness of the frame is at least equal to the thickness of the transparent sheet.

19. The method of claim 18 wherein the transparent sheet is a sheet of clear acrylic.
